(19) United States
(12) Patent Application Publication
(10) Pub. No.: US 2024/0375186 A1
(43) Pub. Date: Nov. 14, 2024

(54) Toolless Socket Change Mechanism

(71) Applicant: Milwaukee Electric Tool Corporation, Brookfield, WI (US)

(72) Inventor: Mitchell Gibson, Brookfield, WI (US)

(21) Appl. No.: 18/657,403

(22) Filed: May 7, 2024

Related U.S. Application Data
(60) Provisional application No. 63/500,889, filed on May 8, 2023.

(51) Int. Cl. B23B 31/107

(52) U.S. Cl. CPC B23B 31/1071; B23B 31/10741; B23B 31/1079

(57) ABSTRACT

A power tool includes an output assembly defining a drive axis. A first socket rotatable by the output assembly in a first rotational direction. A second socket receives the first socket and is rotatable by the output assembly in a second rotational direction. A collar is coupled to the output assembly and is movable along the drive axis to releasably engage with the second socket.

### CROSS-REFERENCE TO RELATED APPLICATIONS

This application claims the benefit of U.S. Provisional Patent Application No. 63/500,889, filed May 8, 2023, which is incorporated herein by reference in its entirety.

### BACKGROUND

Tension control (TC) and/or shear wrenches are typically used in the manufacture of high-strength and/or high-load buildings (e.g., metal buildings, skyscrapers, etc.) to control the tension (e.g., torque, tightness) of a fastener. In one example, TC wrenches are configured to shear-off (e.g., remove) an end and/or spline portion of a tension control (TC) fastener after reaching a predetermined tension.

### SUMMARY

Embodiments of the disclosure provide a power tool (e.g., a shear wrench). The power tool can include an output assembly defining a drive axis, a first socket rotatable by the output assembly in a first rotational direction, a second socket that receives the first socket and is rotatable by the output assembly in a second rotational direction, and a collar coupled to the output assembly and movable along the drive axis to releasably engage with the second socket.

Embodiments of the disclosure provide a power tool. The power tool can include an output assembly, a first socket operatively coupled to the output assembly, a second socket operatively coupled to the output assembly, and a collar. The second socket can secure the first socket to the output assembly. The collar can move between a first position that secures the second socket to the output assembly and a second position that releases the second socket from the output assembly.

Embodiments of the disclosure provide a shear wrench. The shear wrench can include an output assembly defining a drive axis, an inner socket coupled to the output assembly, which can rotate in a first rotational direction about the drive axis, an outer socket concentric with the inner socket and coupled to the output assembly, which can rotate in a second rotational direction about the drive axis, a collar concentric with the outer socket and moveably between a first position and a second position, which can releasably couple the outer socket to the output assembly, and a locking mechanism. The locking mechanism can be positioned between the collar and the outer socket. The collar can engage the locking mechanism in the first position to secure the outer pocket to the output assembly and can disengage the locking mechanism in the second position to release the outer socket from the output assembly.

In some embodiments, the collar can engage the second socket when the second socket is inserted into the output end, which can lock the second socket to the output end. Further, the collar can disengage with the second socket when the collar is moved axially along the drive axis in a first direction, which can release the second socket from the output end. In some embodiments, the power tool can include a locking mechanism positioned between the second socket and the collar, which can be received in a groove defined in the second socket. In some embodiments, the collar can engage the locking mechanism in a first position to move the locking mechanism into the groove, which can lock the second socket to the output end. The collar can disengage from the locking mechanism in a second position, which can release the second socket from the output end. In some embodiments, the locking mechanism can be a ball detent. In some embodiments, the power tool can include a spring sleeve between the collar and the second socket, and the spring sleeve can engage with the locking mechanism. In some embodiments, the first socket can include a first protrusion and the second socket can include a second protrusion. The second protrusion can engage with the first protrusion, which can retain the first socket on the output assembly. In some embodiments, the first socket can include a pin that is movable between a first position, which couples the first socket to the second socket, and a second position, which decouples the first socket from the second socket. In some embodiments, the pin can be received in an opening defined in the first socket, and the pin can engage a recess defined in the second socket. In some embodiments, an ejector pin can move within a cavity of the first socket based on insertion of a fastener into the first socket. The movement of the ejector pin can cause the pin to move between a first position and a second position.

In some embodiments, the collar can move along a drive axis of the output assembly between the first position and the second position. In some embodiments, the power tool can include a ball detent that is moveably coupled to the output assembly between the collar and the second socket. In some embodiments, the collar moving the ball detent can engage the ball detent with the second socket when the collar is in the first position. In some embodiments, the collar can be biased into the first position by a spring that can extend between the collar and the output assembly. In some embodiments, a spring sleeve can be positioned between the collar and the ball detent. The spring sleeve can be resiliently compressed by the collar when the collar is in the first position.

In some embodiments, the shear wrench can include a spring sleeve between the collar and the outer socket. The spring sleeve can be compressed by the collar in the first position to force the locking mechanism to engage the outer socket. In some embodiments, the shear wrench can include a spring that biases the collar to the first position. The spring can extend between the output assembly and a protrusion that extends from an inner surface of the collar to engage the spring sleeve. In some embodiments, securing the outer socket to the output assembly can secure the inner socket to the output assembly. In some embodiments, the locking mechanism can be a ball detent that is moveably secured in an opening in the output assembly.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a side view of a non-limiting example of a power tool according to aspects of the present disclosure.

FIG. 2 is a partial perspective view of an output end of the power tool of FIG. 1 with a collar in a first position.

FIG. 3 is another partial perspective view of an output end of the power tool of FIG. 1 with the collar in a second position.

FIG. 4 is a partial cross-sectional view of the output end of the power tool of FIG. 1 with the collar in the first position.

FIG. 5 is partial cross-sectional view of the output end of the power tool of FIG. 1 with the collar in the second position.

FIG. 6 is a side view of a socket of the power tool of FIG. 2.

FIG. 7 is a partial cross-sectional view of another example of an output end for the power tool of FIG. 1, according to aspects of the present disclosure.

FIG. 8 is a perspective view of a spring sleeve of the power tool of FIG. 7.

FIG. 9 is a cross-sectional view of another socket arrangement for the power tool of FIG. 1 with pins of an inner socket engaged with an outer socket.

FIG. 10 is another cross-sectional view of the socket arrangement of FIG. 9 with the pins of the inner socket disengaged from the outer socket.

### DETAILED DESCRIPTION

Disclosed embodiments will now be described more fully hereinafter with reference to the accompanying drawings, in which some, but not all of the disclosed embodiments are shown. Indeed, several different embodiments may be provided and should not be construed as limited to the embodiments set forth herein. Rather, these embodiments are provided so that this disclosure will be thorough and complete and will fully convey the scope of the disclosure to those skilled in the art.

The disclosed power tool will be described with respect to an example shear wrench. However, it should be understood that any one or more example embodiments of the disclosed shear wrench could be incorporated in alternate forms of a power tool. Furthermore, it should be understood that one or more example embodiments of the disclosed power tool could be used outside of the context of a shear wrench and could more generally be used in a mechanism and/or mechanisms that tightens bolts, such as, for example, power wrenches, electric torque wrenches, and impact wrenches.

In one example, the shear wrench described below is configured to tighten a fastener, and more specifically a tension control bolt, which are commonly used to connect beams in the construction of high-strength and/or high-load structures (e.g., cell towers, bridges, and steel building frames, etc.). In general, a shear wrench includes an output assembly that houses a motor. The motor is operatively coupled to the output assembly having an output end. A first socket (e.g., an inner socket) and a second socket (e.g., an outer socket) can be removably coupled to the output end of the output assembly and configured to engage with and apply a torque to a fastener. The first socket and the second socket are configured to counter-rotate to apply the torque to the fastener.

More specifically, the first socket and the second socket may be configured to releasably couple to the output end of the output assembly. By having the first socket and the second socket releasably couple to the output end of the output assembly, the first socket and second socket may be changed or replaced in the shear wrench to secure different sizes of tension control bolts. Conventionally, in order to change the first socket and the second socket of the shear wrench, a user would typically carry an additional separate tool (e.g., a screwdriver or an Allen wrench) and use the additional tool to separate the first socket and the second socket from the shear wrench. These additional tools can be cumbersome to use while switching out sockets during the manufacture of high-strength and/or high-load buildings, particularly when these switches typically occur high above the ground.

Thus, according to an aspect of the disclosure, the first socket and the second socket are configured to removably couple to an output end of the output assembly without the use of additional tools. In particular, a collar is provided to releasably engage with the second socket to disengage the second socket from the output end of the output assembly or lock the second socket to the output end of the output assembly. The collar can be hand-manipulated by a user. By providing a collar to releasably engage with the second socket, users of the shear wrench can easily and conveniently switch out the first socket or second socket of the shear wrench to fasten different sizes of fasteners without having to use additional tools.

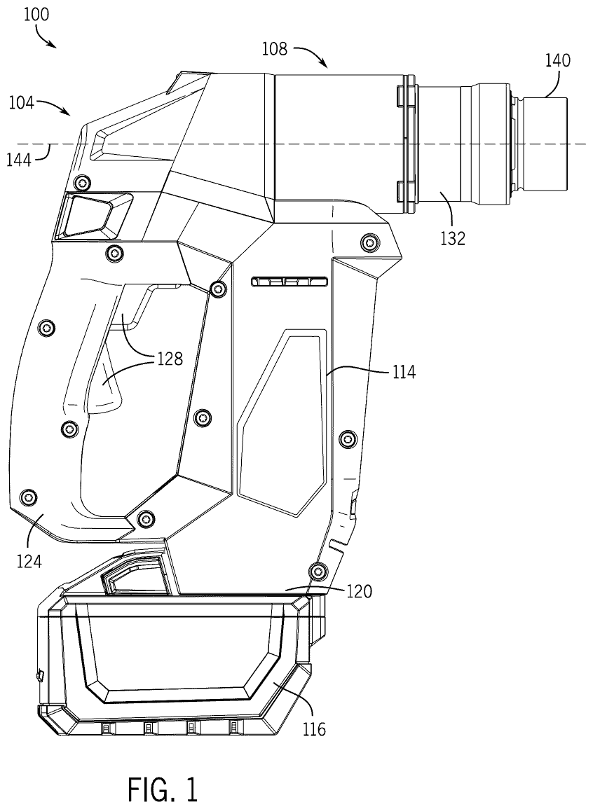

To that end, FIG. 1 illustrates a non-limiting example of a power tool 100 according to aspects of the disclosure. As illustrated, the power tool 100 is configured as a shear wrench, but the principles described herein can also be applied to other types of power tools (e.g., drills, impact wrenches, etc.). In general, the power tool 100 can include a tool body 104 and an output assembly 108 secured to (e.g., above) the tool body 104. The tool body 104 can have a clamshell construction with a first half and a second half that are joined together, or it can be a unitary body. In any case, the tool body 104 can define an interior space in which various components of the power tool 100 can be housed.

In particular, the tool body 104 can include a motor housing 114 configured to house a motor (e.g., a brushless DC motor) that can be operatively coupled to supply a torque to the output assembly 108. The motor can be powered by a power source 116. In the illustrated example, the power source 116 is configured as a battery, and more specifically a lithium ion battery. In some embodiments, the power source 116 could be a different kind of battery, such as, for example, an alkaline battery, a nickel-cadmium battery, or another type of battery chemistry. The power source 116 may also be a rechargeable battery. In other cases, different types of power sources can be provided, including, for example, a power cord configured to supply AC electrical power. The power source 116 can be coupled to the tool body 104 at a connection port 120, which is positioned at a bottom of the tool body 104.

To control a flow of power to the motor, the tool body 104 can further include a user interface, here, configured as a handle 124. The handle 124 can provide a location whereby a user can grip and manipulate the power tool 100. Additionally, the handle 124 can include one or more triggers 128 to control the flow of power from the power source 116 to the motor. For example, depressing a trigger 128 can send a signal to a controller. The controller can receive the signal and control the flow of power from the power source 116 to the motor.

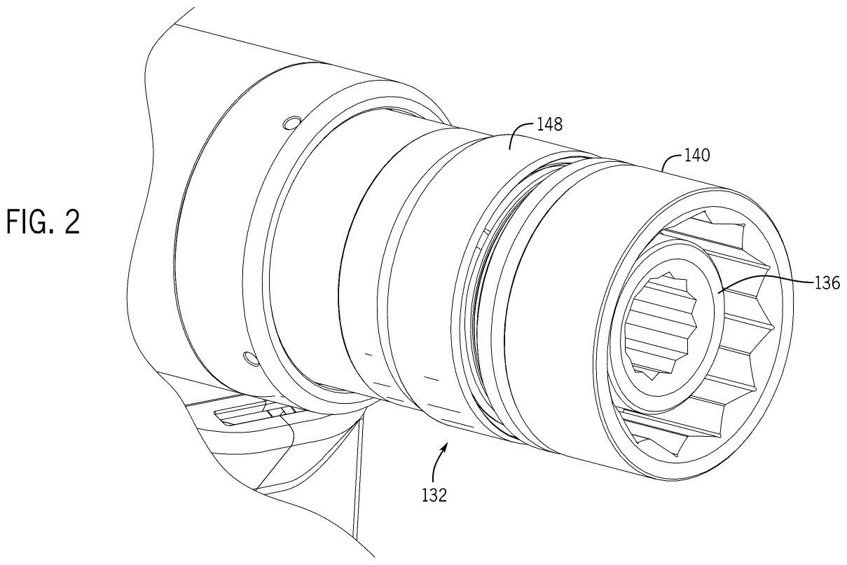

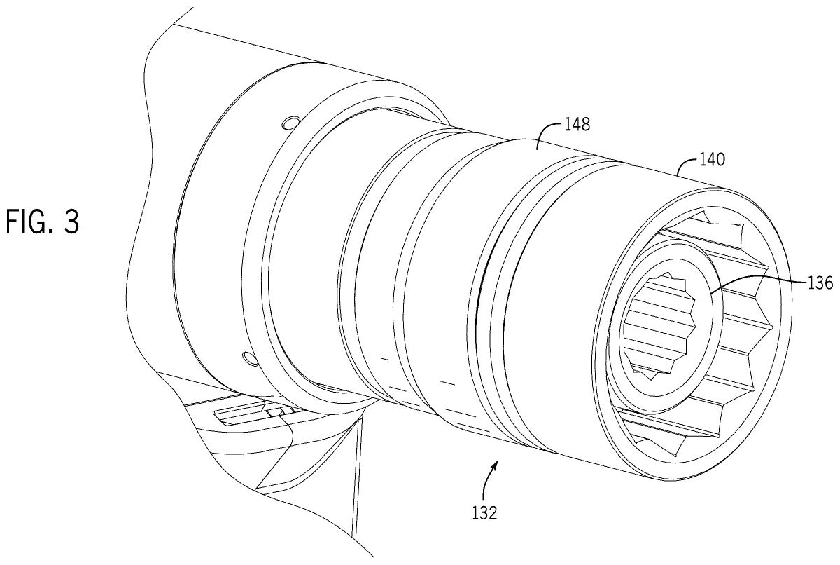

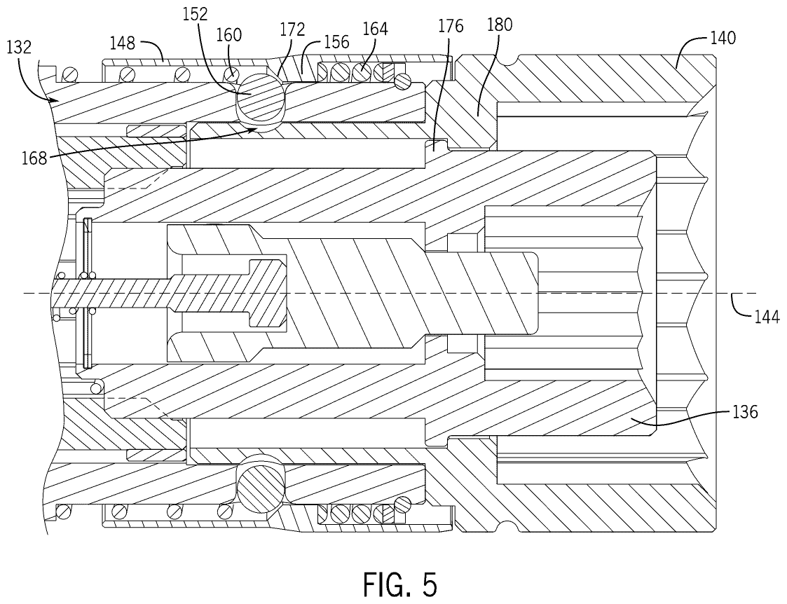

Supplying power to the motor can cause the motor to spin to supply a torque to the output assembly 108 to tighten a fastener. To that end, the output assembly 108 can define an output end 132 configured to support or couple to a means for coupling to a fastener. With additional reference to FIGS. 2-5, in the illustrated example, the coupling means is configured as a concentric socket arrangement that includes a first socket 136 (e.g., an inner socket) and a second socket 140 (e.g., an outer socket). The first socket 136 and the second socket 140 are removably coupled to the output end 132 of the output assembly 108. The second socket 140 at least partially surrounds the first socket 136 and, in some cases, fully surrounds the first socket 136. The first socket 136 can be configured to engage with a spline or head of a tension control bolt and the second socket 140 can be configured to engage with a nut of the tension control bolt. Correspondingly, under power from the motor, the first socket 136 and the second socket 140 can counter rotate around a drive axis 144. The counter rotation causes the head of the tension control bolt to move in an opposite direction compared to the nut of the tension control bolt, thereby applying a desired torque or tension to the tension control bolt (e.g., to transmit torque from the motor to the tension control bolt).

As previously mentioned, in conventional arrangements, in order to remove the first socket 136 and the second socket 140 of the power tool 100, a user typically carries an additional separate tool (e.g., a screwdriver, an Allen wrench, chuck key, etc.) to separate the first socket 136 and the second socket 140 from the power tool 100. However, according to embodiments of this disclosure, the first socket 136 and the second socket 140 can be removed from the power tool 100 by providing a collar 148, without the use of additional tools (e.g., by hand). The collar 148 is configured to be coupled to the output end 132 of the output assembly 108. The collar 148 can at least partially surround the output end 132 of the output assembly 108 and/or the second socket 140 (e.g., to be concentric with the first socket 136 and the second socket 140). The collar 148 is configured to be movable axially along a drive axis 144 and is configured to releasably engage with second socket 140. In other examples, the collar 148 can rotate about the drive axis 144 to releasably engage with second socket 140.

In a non-limiting example, when the second socket 140 is inserted into the output end 132 of the output assembly 108, the collar 148 is configured to engage with the second socket 140, locking the second socket 140 to the output end 132 of the output assembly 108. Locking the second socket 140 to the output end 132 of the output assembly 108 means the second socket 140 is positionally locked against movement along and perpendicular to the drive axis 144 (e.g., both axial and radial translation), while also being allowed to rotate about the drive axis 144 relative to the tool body 104. When the collar 148 is moved axially along the drive axis 144 in a first direction, the collar 148 is configured to disengage with the second socket 140, releasing the second socket 140 from the output end 132. The first direction can correspond with moving (e.g., pushing) the collar 148 toward the handle 124 of the power tool 100 or the first direction can correspond with moving (e.g., pulling) the collar 148 away from the handle 124 of the power tool 100. In the illustrated example, the first direction is such that the collar 148 is moved toward the second socket 140 and away from the tool body 104. In other embodiments, the collar 148 can move differently to secure and release the second socket 140. For example, the collar 148 can be rotated (e.g., in a first direction) about the drive axis 144.

In some embodiments, the output end 132 of the output assembly 108 further includes a locking mechanism 152 located between the second socket 140 and the collar 148, which is actuated by the collar 148. In some cases, multiple locking mechanisms 152 may be used. Alternatively, only one locking mechanism 152 may be used. The locking mechanism 152 can be, for example, a ball detent, a ball plungers, a spring plungers, a locking balls, a protrusions, a bearings, etc. The locking mechanism 152 may be made from rubber, metal (e.g., steel), ceramics, etc.

The collar 148 can further include a collar protrusion 156 located on an inner surface of the collar 148. A first spring 160 can be located on a first side of the collar protrusion 156 between the collar 148 and the output end 132 of the output assembly 108. A second spring 164 can be located on a second side (e.g., opposite the first side) of the collar protrusion 156 between the collar 148 and the output end 132 of the output assembly 108. The first spring 160 and second spring 164 are configured to bias the collar 148 into position on the output end 132 (e.g., a first or locked position).

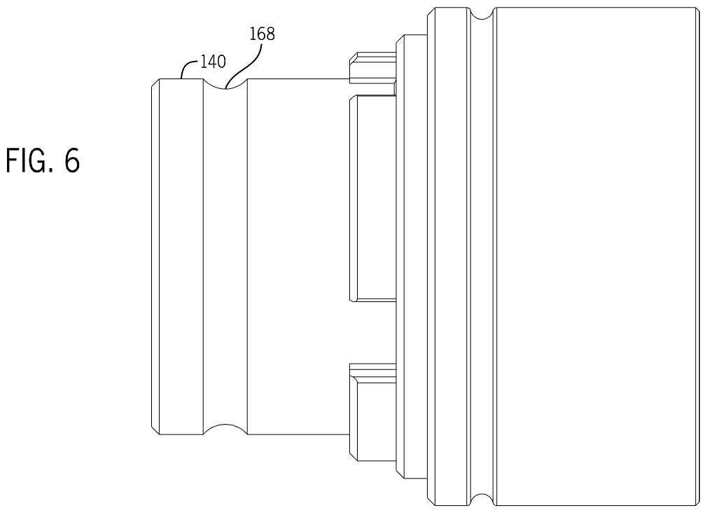

Relatedly, and as is described in greater detail below, the second socket 140 can include a groove 168 on an outer surface of the second socket 140 (see FIG. 6), which can be configured to engage with the locking mechanism 152 when the collar 148 is in the locked position. In some instances, the groove 168 can fully extend around a circumference of the second socket 140.

To provide the releasable engagement between the second socket 140 and the collar 148 and output end 132, the locking mechanism 152, the collar protrusion 156, the first spring 160, the second spring 164, and the groove 168 can work together to removably couple the second socket 140 to the output end 132 of the output assembly 108.

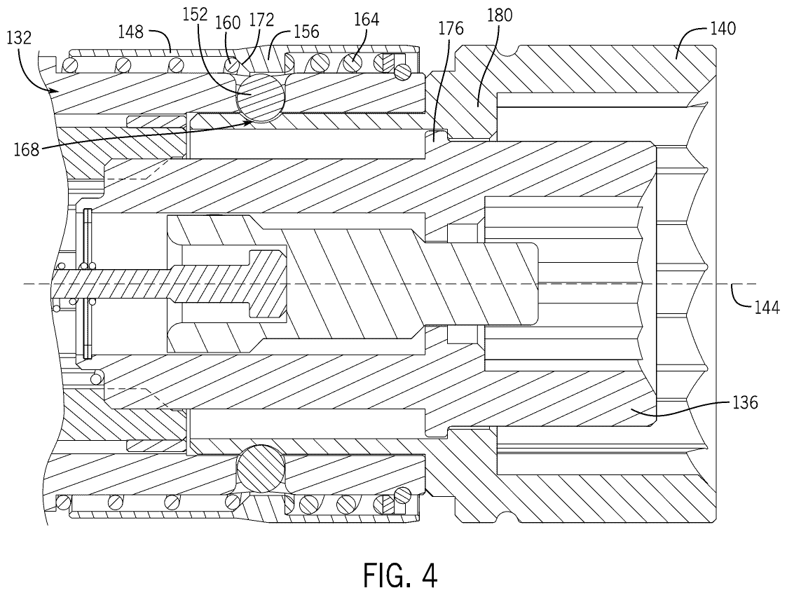

For example, to couple the second socket 140 to the output end 132 of the output assembly 108, the second socket 140 is inserted into the output end 132 of the output assembly 108. When the second socket 140 is inserted into the output end 132 of the output assembly 108, the first spring 160 and/or the second spring 164 is configured to bias the collar protrusion 156 into a locked position (e.g., a first position, see FIGS. 2 and 4) to engage with the locking mechanism 152 and force the locking mechanism 152 into the groove 168. In other words, as the second socket 140 is inserted into the output end 132, the first spring 160 and/or the second spring 164 cause the collar protrusion 156 to move to a position to transfer a force to the second socket 140 via the locking mechanism 152. When the locking mechanism 152 is aligned with the groove 168, the locking mechanism 152 is pushed into the groove 168 via the collar protrusion 156 by the collar protrusion 156. The collar protrusion 156 retains the locking mechanism 152 in the groove 168 to secure the second socket 140 to the output assembly 108. Put another way, the force transferred between the collar protrusion 156 and the groove 168 via the locking mechanism 152 locks the second socket 140 to the output end 132. In some cases, a surface 172 of the collar protrusion 156 can be sloped (e.g., chamfered) to provide a lead-in feature that reduces the force necessary engage with the locking mechanism 152 and lock the second socket 140 to the output end 132.

To remove the second socket 140 from the output end 132 of the output assembly 108, the collar 148 is moved axially in a first direction along the drive axis 144 extending or compressing the first spring 160 and the second spring 164 (e.g., via a user pulling or pushing on the collar 148). When the collar 148 is moved axially along the drive axis 144 in the first direction, the collar protrusion 156 disengages from the locking mechanism 152. When the collar protrusion 156 disengages with the locking mechanism 152, a space is formed between the locking mechanism 152 and the collar 148 that allows the locking mechanism 152 to move radially outward from the groove 168. Accordingly, the force between the collar protrusion 156, locking mechanism 152, and the groove 168 is released, allowing the second socket 140 to be disengaged from the output end 132. More specifically, as the second socket 140 is removed from the output end 132, the locking mechanism 152 is forced upwards and out of the groove 168 by the relative movement of the second socket 140. The void created by the collar 148 to disengage the protrusion 156 from the locking mechanism 152 accommodates this radial movement of the locking mechanism 152 while retaining the locking mechanism 152 in the output end 132.

Still referring to FIG. 4, to removably attach the first socket 136 to the output end 132 of the output assembly 108, the first socket 136 can have a first socket protrusion 176 on an outer surface of the first socket 136 and the second socket 140 can have a second socket protrusion 180 on an inner surface of the second socket 140. The first socket protrusion 176 can extend around an entire circumference of the outer surface of the first socket 136. The second socket protrusion 180 can extend around an entire circumference of the inner surface of the second socket 140. When the second socket 140 is inserted into the output end 132 of the output assembly 108, the second socket protrusion 180 can contact the first socket protrusion 176 causing a force to push the first socket 136 into the output end 132 and locking the first socket 136 within the output end 132. Locking the first socket 136 within the output end 132 of the output assembly 108 means the first socket 136 is positionally locked against movement along and perpendicular to the drive axis 144 (e.g., both axial and radial translation), while also being allowed to rotate about the drive axis 144 relative to the tool body 104.

To disengage the first socket 136 from the output end 132 of the output assembly 108, the collar 148 is moved axially in a first direction along the drive axis 144. When the collar 148 is moved axially along the drive axis 144 in the first direction, the force between the second socket protrusion 180 and the first socket protrusion 176 is released making it easy to remove or release the first socket 136 from the output end 132. In this way, the first socket 136 is interchangeable within the power tool 100.

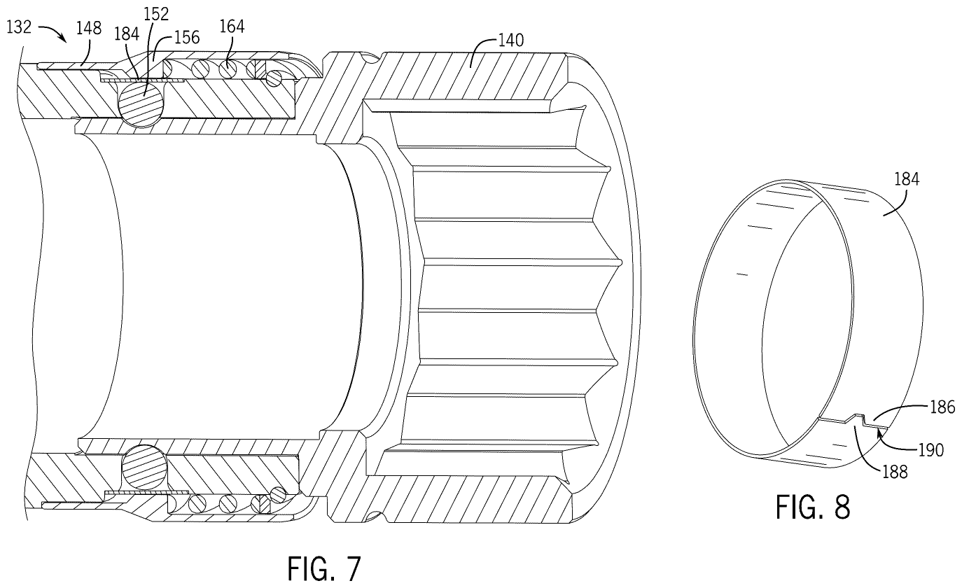

Continuing, FIG. 7 illustrates a second embodiment of the output end 132 of the output assembly 108 of the power tool 100. The second embodiment of the output end 132 of the output assembly 108 is similar to the first embodiment but adds an optional spring sleeve 184. As shown in FIG. 8, the spring sleeve 184 can be a thin cylindrical body made from metal. In some cases, the spring sleeve 184 can be used to replace the first spring 160 (see, e.g., FIG. 4). The spring sleeve 184 and the second spring 164 are configured to bias the collar 148 into position on the output end 132. In alternative cases, the spring sleeve 184 can be used in addition to the first spring 160. The first spring 160, the spring sleeve 184, and the second spring 164 are configured to bias the collar 148 into position on the output end 132. By providing the spring sleeve 184, the collar protrusion 156 can more smoothly contact the locking mechanism 152 when the second socket 140 is inserted into the output end 132 and more smoothly disengage from the locking mechanism when the collar 148 is moved axially along the drive axis 144 in the first direction. Additionally, the spring sleeve 184 can more easily transfer the force from the collar protrusion 156 to the locking mechanism 152 to lock the second socket 140 in place within the output end 132. As previously mentioned, in some embodiments, the spring sleeve 184 is a piece of metal that is bent into a cylindrical shape. The spring sleeve 184 can include a break in the cylinder so that the spring sleeve 184 has free distal ends 186, 188 that are separated by a gap 190. When the collar protrusion 156 engages with the spring sleeve 184, the spring sleeve 184 is resiliently compressed to bring the distal ends 186, 188 together to reduce or close the gap 190. This reduces the effective diameter of the spring sleeve 184 and causes the spring sleeve 184 to engage with the locking mechanism 152. Thus, the locking mechanism 152 is moved to the locked position. However, when collar 148 is activated so that the collar protrusion 156 no longer engages with the spring sleeve 184, the resilient nature of the spring sleeve cause the distal ends 186, 188 to move away from one another, widening the gap 190 and increasing the effective diameter of the spring sleeve 184. As a result, the spring sleeve 184 no longer engages with the locking mechanism 152 (e.g., to apply a force that moves the locking mechanism into the groove 168), and the locking mechanism 152 can exit the groove 168. As a result, the locking mechanism 152 is in an unlocked position, allowing the first socket 136 and the second socket 140 to be removed from the power tool 100.

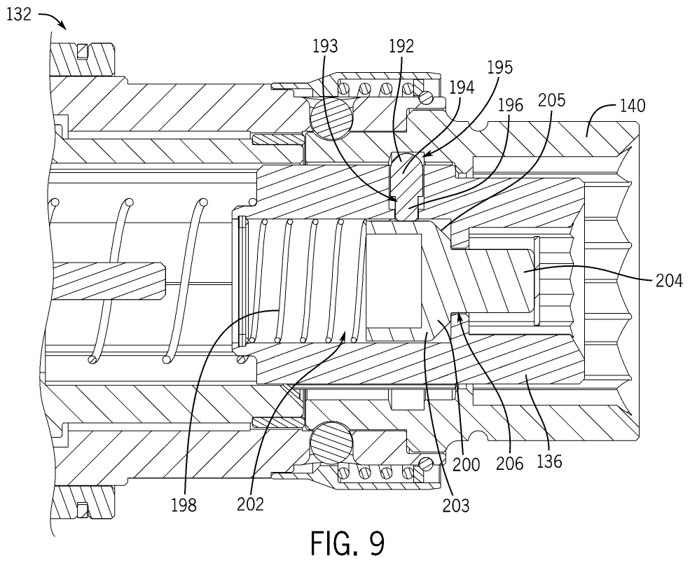

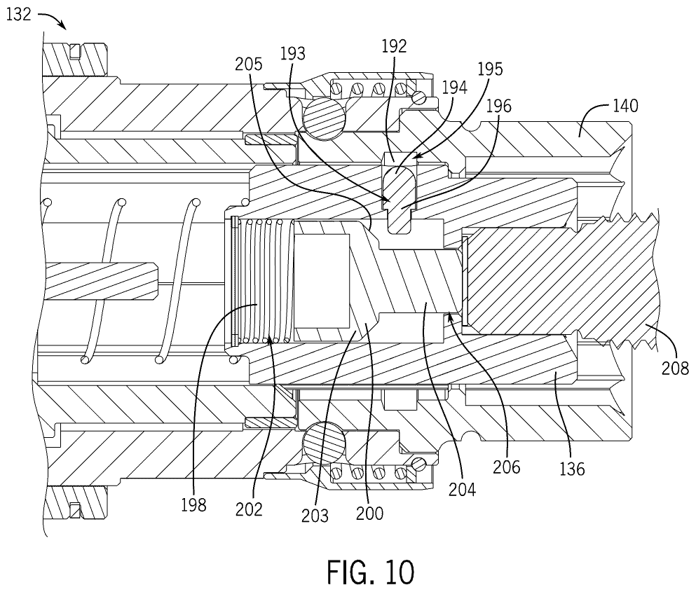

In some examples it can be useful to allow an inner socket and an outer socket to be inserted or removed together as single unit. Accordingly, in some examples, the inner socket and the outer socket can be configured to couple together for co-insertion or removal, while still allowing for relative rotation there between (e.g., counter-rotation). For example, as shown in FIGS. 9 and 10, a socket assembly can optionally include a pin 192 (e.g., a detent) that can move between a first position to couple the inner socket 136 to the outer socket 140 and a second position the decouples the inner socket 136 from the outer socket 140. In some examples the pin 192 is disposed in an opening 193 defined in the first socket 136. The pin 192 can move radially within the opening 193 to engage and disengage the second socket 140. In some cases, the pin 192 can engage a recess 195 defined by the second socket 140. The recess 195 can be formed as a circumferential channel to allow for relative rotation of the first socket 136 and the second socket 140 when the pin 192 is received in the recess 195 (e.g., to couple the first socket 136 to the second socket 140). In other examples, the pin 192 arrangement can be provided in the second socket 140.

Actuation of the pin 192 can be controlled in various ways. In some examples, the pin 192 can be biased into engagement with the second socket 140 by a biasing element. In some examples, the pin 192 can be moved in accordance with insertion of a fastener into the power tool 100. For example, still referring to FIGS. 9 and 10, the first socket 136 includes a cavity 202 that moveably receives an ejector pin 200 therein. Correspondingly, the opening 193 is connected with the cavity 202 and the pin 192 includes a head 194 that engages the second socket 140 and a shaft 196 that extends into the cavity 202 to engage with the ejector pin 200. The ejector pin 200 can move between a first position and a second position based on the insertion and removal of a fastener 208 from the first socket 136. For example, the ejector pin 200 includes a head 203 that engages the pin 192 in the cavity 202 and a shaft 204 that extends through an aperture 206 in the base of the cavity 202 in the first socket 136 to engage with the fastener 208. The head 203 has a larger diameter than the shaft 204. Inserting a fastener 208 (see FIG. 10) into the first socket 136 causes the fastener to apply a force to the ejector pin 200. Insertion and removal of the fastener 208 induces movement of the ejector pin 200, which in turn, induces movement of the pin 192.

FIG. 9 shows the ejector pin 200 in the first configuration, where the fastener 208 is removed from the first socket 136. In the first position, the ejector pin 200 is moved to the base of the cavity 202 so that that head 203 engages the shaft 196 of the pin 192. This shifts the pin 192 radially outward to engage the second socket 140. In the first position, the shaft 204 of the ejector pin 200 extends through the aperture 206. The ejector pin 200 can be biased to the first position by a biasing member 198 (e.g., a spring, rubber bushing, or another resilient member), which may be positioned in the cavity 202.

FIG. 10 shows the ejector pin 200 in the second position where the fastener 208 is received in the first socket 136 (e.g., which compresses the biasing member 198). In the second position, the ejector pin 200 is moved away from the base of the cavity 202 so that the head 203 is moved out of engagement with the shaft 196 of the pin 192. The removes the biasing force on the pin 192 and allows the pin 192 to disengage from the second socket 140. More specifically, the pin 192 moves radially inward so that the shaft 196 extends into the cavity. The head 194 of the pin 192 remains disposed in the opening 193, with a base of the head 194 engaged with a base of the opening 193. Upon removing the fastener 208 from the inner socket 136, the biasing member 198 can decompress to return the ejector pin 200 to the first position. In some case, the head 203 of the pin can include a ramped surface 205 or other lead in feature to guide movement of the pin 192.

In this way, the embodiments disclosed herein provide a power tool 100 with a removable first socket 136 and a removable second socket 140. By configuring a collar 148 to move axially along a drive axis, the removable first socket 136 and the removable second socket 140 may be removed from the power tool without the use of any additional tools.

As used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, the use of “including,” “comprising,” or “having” and variations thereof herein is meant to encompass the items listed thereafter and equivalents thereof as well as additional items. Unless specified or limited otherwise, the terms “mounted,” “connected,” “supported,” “attached,’ and “coupled” and variations thereof are used broadly and encompass both direct and indirect mountings, connections, supports, and couplings.

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A power tool comprising:
an output assembly defining a drive axis;
a first socket rotatable by the output assembly in a first rotational direction;
a second socket that receives the first socket and is rotatable by the output assembly in a second rotational direction; and
a collar coupled to the output assembly and movable along the drive axis to releasably engage with the second socket.

2. The power tool of claim 1, wherein the collar engages the second socket when the second socket is inserted into the output assembly to lock the second socket to the output assembly, and the collar disengages with the second socket when the collar is moved axially along the drive axis in a first direction to release the second socket from the output assembly.

3. The power tool of claim 1 further comprising a locking mechanism positioned between the second socket and the collar to be received in a groove defined in the second socket.

4. The power tool of claim 3, wherein the collar engages the locking mechanism in a first position to move the locking mechanism into the groove to lock the second socket to the output assembly and the collar disengages from the locking mechanism in a second position to release the second socket from the output assembly.

5. The power tool of claim 3, wherein the locking mechanism is a ball detent.

6. The power tool of claim 3 further comprising a spring sleeve between the collar and the second socket to engage with the locking mechanism.

7. The power tool of claim 3, wherein the first socket includes a first protrusion and the second socket includes a second protrusion that engages with the first protrusion to retain the first socket on the output assembly.

8. The power tool of claim 1, wherein the first socket includes a pin that is movable between a first position that couples the first socket to the second socket and a second position that decouples the first socket from the second socket.

9. The power tool of claim 8, wherein the pin is received in an opening defined in the first socket and engages a recess defined in the second socket.

10. The power tool of claim 9, wherein an ejector pin moves within a cavity of the first socket based on insertion of a fastener into the first socket, the movement of the ejector pin causing the pin to move between the first position and the second position.

11. A power tool comprising:
an output assembly;
a first socket operatively coupled to the output assembly;
a second socket operatively coupled to the output assembly, the second socket securing the first socket to the output assembly; and
a collar movable between a first position that secures the second socket to the output assembly and a second position that releases the second socket from the output assembly.

12. The power tool of claim 11, wherein the collar moves along a drive axis of the output assembly between the first position and the second position.

13. The power tool of claim 11 further comprising a ball detent moveably coupled to the output assembly between the collar and the second socket, the collar moving the ball detent to engage with the second socket when the collar is in the first position.

14. The power tool of claim 13, wherein the collar is biased into the first position by a spring that extends between the collar and the output assembly.

15. The power tool of claim 14, wherein a spring sleeve is positioned between the collar and the ball detent, the spring sleeve being resiliently compressed by the collar when the collar is in the first position.

16. A shear wrench comprising:
an output assembly defining a drive axis;
an inner socket coupled to the output assembly to rotate in a first rotational direction about the drive axis;
an outer socket concentric with the inner socket and coupled to the output assembly and to rotate in a second rotational direction about the drive axis;
a collar concentric with the outer socket and moveable between a first position and a second position to releasably couple the outer socket to the output assembly; and
a locking mechanism positioned between the collar and the outer socket, the collar engaging the locking mechanism in the first position to secure the outer socket to the output assembly and disengaging the locking mechanism in the second position to release the outer socket from the output assembly.

17. The shear wrench of claim 16, further comprising a spring sleeve between the collar and the outer socket, the spring sleeve being compressed by the collar in the first position to force the locking mechanism to engage the outer socket.

18. The shear wrench of claim 17 further comprising a spring that biases the collar to the first position, the spring extending between the output assembly and a protrusion that extends from an inner surface of the collar to engage the spring sleeve.

19. The shear wrench of claim 16, wherein securing the outer socket to the output assembly secures the inner socket to the output assembly.

20. The shear wrench of claim 19, wherein the locking mechanism is a ball detent that is moveably secured in an opening in the output assembly.
